(19) United States
(12) Patent Application Publication
(10) Pub. No.: US 2018/0005320 A1
(43) Pub. Date: Jan. 4, 2018

(54) METHOD AND SYSTEM FOR CURRENCY EXCHANGE

(71) Applicant: MasterCard Asia/Pacific Pte Ltd, Singapore (SG)

(72) Inventors: Donghao Huang, Singapore (SG); Ai Ling Felicia Choo, Singapore (SG); Naman Aggarwal, Singapore (SG)

(21) Appl. No.: 15/628,676

(22) Filed: Jun. 21, 2017

(30) Foreign Application Priority Data
Jun. 30, 2016 (SG) 10201605382Y

(51) Int. Cl. G06Q 40/04; G06Q 20/26; G06Q 20/24; G06Q 20/32; G06Q 20/22

(52) U.S. Cl. CPC G06Q 40/04; G06Q 20/3223; G06Q 20/227; G06Q 20/24; G06Q 20/26

(57) ABSTRACT

A method for currency exchange, comprising: providing, by an account management module, an account each for first and second entities, each account comprising a plurality of sub-accounts for a different currency; broadcasting a currency exchange rate between a first currency and second currency; receiving, at a transaction management module in communication with the account management module, a request from the second entity for an amount of the first currency in exchange for the second currency at the broadcasted rate; determining, by the transaction management module, an equivalent amount of the second currency at the broadcasted rate; debiting the determined amount of the second currency from the second entity, and crediting said amount to the first entity, by the account management module; and debiting the requested amount of the first currency from first entity and crediting said amount to the second entity, by the account management module.

### CROSS REFERENCE TO RELATED APPLICATION

This application is a U.S. National Stage filing under 35 U.S.C. §119, based on and claiming benefit of and priority to SG Patent Application No. 10201605382Y filed Jun. 30, 2016.

### FIELD OF INVENTION

The present invention relates broadly, but not exclusively, to methods and systems for currency exchange.

### BACKGROUND

Most banks charge a hefty service fee when a traveller makes an overseas ATM withdrawal. As such, travellers often exchange currencies at a currency exchange counter prior to travelling overseas. This often results in the traveller over-changing the amount of foreign currencies they require. Unused foreign currencies tend to be left aside once a traveller returns home. Oftentimes, traveller chooses not to exchange these unused currencies back to the home currency because of the commissions charged at the exchange counter and unfavourable rate spreads.

A need therefore exists to provide methods and systems for currency exchange that seek to address at least some of the above problems.

### SUMMARY

According to a first aspect, there is provided a method for currency exchange between a first entity and a second entity, comprising: providing, by an account management module, an account each for the first and second entities, each account comprising a plurality of sub-accounts for a different currency; broadcasting a currency exchange rate between a first currency and a second currency; receiving, at a transaction management module in communication with the account management module, a request from the second entity for a requested amount of the first currency in exchange for the second currency at the broadcasted currency exchange rate; determining, by the transaction management module, an equivalent amount of the second currency that is equivalent to the requested amount of the first currency converted based on the broadcasted currency exchange rate; debiting, by the account management module, the determined equivalent amount of the second currency from a sub-account for the second currency that is affiliated with the second entity, and crediting, by the account management module, the debited amount of the second currency into a sub-account for the second currency that is affiliated with the first entity; and debiting, by the account management module, the requested amount of the first currency from a sub-account for the first currency that is affiliated with the first entity, and crediting, by the account management module, the debited amount of the first currency into a sub-account for the first currency that is affiliated with the second entity.

In an embodiment, the method may further comprise receiving, at the transaction management module, an offered currency exchange rate between the first currency and the second currency. The broadcasted currency exchange rate may be based on the offered currency exchange rate.

In an embodiment, the method may further comprise transmitting the offered currency exchange rate from a user input module of the first entity to the transaction management module.

In an embodiment, the method may further comprise receiving, at the transaction management module, a pre-determined currency exchange rate between the first currency and the second currency. The broadcasted currency exchange rate may be based on the pre-determined currency exchange rate.

In an embodiment, the method may further comprise: retrieving, by the account management module, a threshold amount of the second currency to be maintained in the sub-account for the second currency that is affiliated with the first entity; determining, by the account management module, an available amount of the second currency in the sub-account for the second currency that is affiliated with the first entity; comparing, by the account management module, the available amount and the threshold amount of the second currency; and on a condition that the available amount is less than the threshold amount of the second currency, determining, by the transaction management module, a shortfall amount of the second currency corresponding to a difference between the available amount and the threshold amount of the second currency; determining, by the transaction management module, an equivalent shortfall amount of the first currency that is equivalent to the shortfall amount of the second currency converted based on the broadcasted currency exchange rate; debiting, by the account management module, the determined equivalent shortfall amount of the first currency from the sub-account for the first currency that is affiliated with the first entity, and crediting, by the account management module, the shortfall amount of the second currency into the sub-account for the second currency that is affiliated with the first entity.

In an embodiment, the method may further comprise: receiving, at the transaction management module, an indication from the first entity of the second currency in exchange for the first currency; and receiving, at the transaction management module, an indication from the second entity of the first currency in exchange for the second currency. The step of broadcasting the currency exchange rate between the first currency and the second currency may be performed on a condition that the second currency in exchange for the first currency corresponds to the first currency in exchange for the second currency.

In an embodiment, in response to receiving the request from the second entity for the requested amount of the first currency in exchange for the second currency at the broadcasted currency exchange rate, the method may further comprise: determining, by the account management module, an available amount of the second currency in the sub-account for the second currency that is affiliated with the second entity; comparing, by the account management module, the determined available amount and the determined equivalent amount of the second currency; and on a condition that the determined available amount is more than the determined equivalent amount of the second currency, debiting, by the account management module, the determined equivalent amount of the second currency from the sub-account for the second currency that is affiliated with the second entity.

In an embodiment, the step of broadcasting the currency exchange rate between the first currency and the second currency may comprise transmitting the currency exchange rate between the first currency and the second currency from the transaction management module to a user output module of the first entity and/or second entity.

According to a second aspect, there is provided a method for currency exchange for an entity, comprising: providing, by an account management module, an account for the entity, the account comprising a plurality of sub-accounts for a different currency; broadcasting a currency exchange rate between a first currency and a second currency; receiving, at a transaction management module in communication with the account management module, a request for a requested amount of the first currency in exchange for a second currency at the broadcasted currency exchange rate; determining, by the transaction management module, an equivalent amount of the second currency that is equivalent to the requested amount of the first currency converted based on the broadcasted currency exchange rate; and debiting, by the account management module, the determined equivalent amount of the second currency from a sub-account for the second currency, and crediting, by the account management module, the requested amount of the first currency into a sub-account for the first currency.

According to a third aspect, there is provided a system for currency exchange between a first entity and a second entity, comprising: an account management module; and a transaction management module in communication with the account management module, wherein the transaction management module is configured to: broadcast a currency exchange rate between a first currency and a second currency; receive a request from the second entity for a requested amount of the first currency in exchange for the second currency at the broadcasted currency exchange rate; and determine an equivalent amount of the second currency that is equivalent to the requested amount of the first currency converted based on the broadcasted currency exchange rate, and wherein the account management module is configured to: provide an account each for the first and second entities, each account comprising a sub-account for the first currency and a sub-account for the second currency; debit the determined equivalent amount of the second currency from a sub-account for the second currency that is affiliated with the second entity, and credit the debited amount of the second currency into a sub-account for the second currency that is affiliated with the first entity; and debit the requested amount of the first currency from a sub-account for the first currency that is affiliated with the first entity, and credit the debited amount of the first currency into a sub-account for the first currency that is affiliated with the second entity.

In an embodiment, the transaction management module may be further configured to receive an offered currency exchange rate between the first currency and the second currency from a user input module of the first entity. The broadcasted currency exchange rate may be based on the offered currency exchange rate.

In an embodiment, the transaction management module may be further configured to receive a pre-determined currency exchange rate between the first currency and the second currency. The broadcasted currency exchange rate may be based on the pre-determined currency exchange rate.

In an embodiment, the account management module may be further configured to: retrieve a threshold amount of the second currency to be maintained in the sub-account for the second currency that is affiliated with the first entity; determine an available amount of the second currency in the sub-account for the second currency that is affiliated with the first entity; and compare the available amount and the threshold amount of the second currency. The transaction management module may be further configured to: determine a shortfall amount of the second currency corresponding to a difference between the available amount and the threshold amount of the second currency; and determine an equivalent shortfall amount of the first currency that is equivalent to the shortfall amount of the second currency converted based on the broadcasted currency exchange rate, on a condition that the available amount is less than the threshold amount of the second currency as determined by the account management module. In addition, the account management module may be further configured to: debit the determined equivalent shortfall amount of the first currency from the sub-account for the first currency that is affiliated with the first entity, and credit the shortfall amount of the second currency into the sub-account for the second currency that is affiliated with the first entity.

In an embodiment, the transaction management module may be further configured to: receive an indication from the first entity of the second currency in exchange for the first currency; receive an indication from the second entity of the first currency in exchange for the second currency; and broadcast the currency exchange rate between the first currency and the second currency on a condition that the second currency in exchange for the first currency corresponds to the first currency in exchange for the second currency.

In an embodiment, in response to the transaction management module receiving the request from the second entity for the requested amount of the first currency in exchange for the second currency at the broadcasted currency exchange rate, the account management module may be further configured to: determine an available amount of the second currency in the sub-account for the second currency that is affiliated with the second entity; compare the determined available amount and the determined equivalent amount of the second currency; and on a condition that the determined available amount is more than the determined equivalent amount of the second currency, debit the determined equivalent amount of the second currency from the sub-account for the second currency that is affiliated with the second entity.

In an embodiment, the transaction management module may be further configured to transmit the currency exchange rate between the first currency and the second currency to a user output module that is in communication with the transaction management module.

According to a fourth aspect, there is provided a system for currency exchange for an entity, comprising: an account management module; and a transaction management module in communication with the account management module, wherein the transaction management module is configured to: broadcast a currency exchange rate between a first currency and a second currency; receive a request for a requested amount of the first currency in exchange for a second currency at the broadcasted currency exchange rate; determine an equivalent amount of the second currency that is equivalent to the requested amount of the first currency converted based on the broadcasted currency exchange rate; and wherein the account management module is configured to: provide an account for the entity, the account comprising a sub-account for the first currency and a sub-account for the second currency; and debit the determined equivalent amount of the second currency from the sub-account for the second currency, and credit the requested amount of the first currency into the sub-account for the first currency.

### BRIEF DESCRIPTION OF THE DRAWINGS

Embodiments will be better understood and readily apparent to one of ordinary skill in the art from the following written description, by way of example only, and in conjunction with the drawings, in which:

FIG. 1 shows a flow chart illustrating a method for currency exchange between a first entity and a second entity, according to an example embodiment;

FIG. 2 shows a schematic of a system for currency exchange between a first entity and a second entity, according to an example embodiment;

FIG. 3 shows a schematic diagram illustrating a first scenario during which method(s) and/or system(s) for currency exchange according to example embodiments may be utilized;

FIG. 4 shows a schematic diagram illustrating a second scenario during which method(s) and/or system(s) for currency exchange according to example embodiments may be utilized;

FIG. 5 shows a schematic diagram illustrating a third scenario during which method(s) and/or system(s) for currency exchange according to example embodiments may be utilized; and

FIG. 6 shows a schematic diagram of a computer system suitable for use in executing one or more steps of the methods for currency exchange according to example embodiments.

### DETAILED DESCRIPTION

Embodiments will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

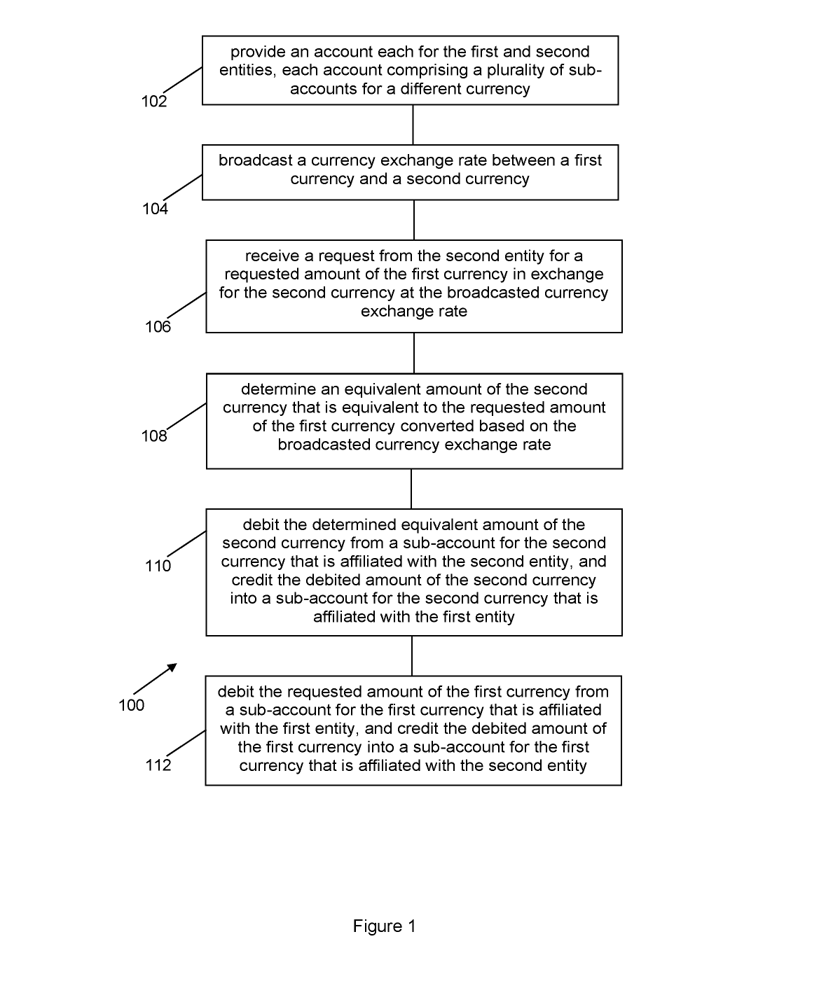

FIG. 1 is a flow chart illustrating a method 100 for currency exchange between a first entity and a second entity, according to an embodiment. The first and second entities may be individual users or corporate entities. It will be appreciated that the method 100 may be extended to involve more than two entities. For example, the first and second entities can participate in a first currency exchange transaction. Thereafter, the second entity and a third entity can participate in a subsequent second currency exchange transaction. For the sake of brevity, the method 100 will be described with reference to two entities only.

The method 100 includes step 102 of providing, by an account management module, an account each for the first and second entities. Each account includes a plurality of sub-accounts for a different currency. In other words, each entity has his/her/its unique account and the account includes a number of sub-accounts, each sub-account for a different type of currency (e.g. US Dollars, Japanese Yen, Australian Dollars, Euros, etc.). One or more account management modules may be used to create and/or manage the accounts (and corresponding sub-accounts) for multiple entities.

The method 100 further includes step 104 of broadcasting a currency exchange rate between a first currency and a second currency. In an implementation, the step 104 of broadcasting the currency exchange rate between the first currency and the second currency may involve transmitting the currency exchange rate from a transaction management module to a user output module of the first entity and/or second entity. The user output module may be part of a mobile electronic device (e.g. smart phone) belonging to the first entity and/or second entity. For example, the user output module may be a display screen with associated processor(s) and microcontroller(s) capable of displaying the currency exchange rate. The first entity and/or second entity may use the user output module to view the broadcasted currency exchange rate.

The transaction management module and account management module will be described in more detail below.

Prior to step 104, the method 100 may further include a step of receiving, at the transaction management module, an offered currency exchange rate between the first currency and the second currency. In such a case, the broadcasted currency exchange rate is based on the offered currency exchange rate. The currency exchange rate may be user-defined and the user can use his/her user input module, which may be part of a mobile electronic device (e.g. smart phone), to indicate the user-defined (i.e. offered) currency exchange rate. The offered currency exchange rate can be transmitted from the user input module of the user (e.g. the first or second entity) to the transaction management module.

Alternatively or in addition, prior to step 104, the method 100 may further include a step of receiving, at the transaction management module, a pre-determined currency exchange rate between the first currency and the second currency. In such a case, the broadcasted currency exchange rate is based on the pre-determined currency exchange rate. The pre-determined currency exchange rate may be set by an administrator of the method 100, and may be based on foreign exchange market rates.

Whether the broadcasted currency exchange rate is based on a “user-defined” offered currency exchange rate or based on a “market-defined” pre-determined currency exchange rate, it will be appreciated that the broadcasted currency exchange rate may not be exactly the same as the offered or pre-determined currency exchange rate. In other words, the broadcasted currency exchange rate may be more or less than the offered or pre-determined currency exchange rate. This is because certain factors have to be taken into account, such as commissions, buffers for currency fluctuations and differences between bid price and offer price.

Furthermore, the broadcasted currency exchange rate may be refreshed and re-broadcasted as necessary, e.g. due to changes in the currency exchange rate over time.

The method 100 further includes step 106 of receiving, at the transaction management module which is in communication with the account management module, a request from the second entity for a requested amount of the first currency in exchange for the second currency at the broadcasted currency exchange rate. In this description of step 106, if the currency exchange rate is user-defined, it is assumed that the first entity has defined the currency exchange and the second entity has agreed to transact based on that rate. It will be appreciated that the first and second entities are merely labels/references to different entities. One entity is chosen as a “requester” or “buyer” (in this example, it is the second entity) and the other entity is designated the “seller” (in this case, it is the first entity). The roles can be reversed in the sense that the second entity may be a “seller” in a subsequent transaction.

The method 100 further includes step 108 of determining, by the transaction management module, an equivalent amount of the second currency that is equivalent to the requested amount of the first currency converted based on the broadcasted currency exchange rate.

As an example, the first currency is US Dollars and the second currency is Euros. Assume that the broadcasted currency exchange rate between US Dollars (USD) and Euros (EUR) is USD 1 to EUR 0.90. Further assume that the second entity has requested for USD 10 in exchange for EUR at the broadcasted currency exchange rate. In this instance, the equivalent amount of EUR that is equivalent to the requested amount of USD, based on the broadcasted currency exchange rate of USD 1 to EUR 0.9, is EUR 9.

The method 100 further includes step 110 of debiting and crediting appropriate amounts of the second currency into the relevant sub-accounts by the account management module. In particular, the step 110 includes sub-step 110a of debiting, by the account management module, the determined equivalent amount of the second currency (as determined at step 108 above, e.g. EUR 9) from a sub-account for the second currency that is affiliated with the second entity. The step 110 further includes sub-step 110b of crediting, by the account management module, the debited amount of the second currency (i.e. debited at sub-step 110a, e.g. EUR 9) into a sub-account for the second currency that is affiliated with the first entity. In other words, the appropriate amount of EUR 9 is debited from the second entity's account and this debited amount of EUR 9 is credited to the first entity's account.

The method 100 further includes step 112 of debiting and crediting appropriate amounts of the first currency into the relevant sub-accounts by the account management module. Step 112 is performed “in exchange” for the debiting and crediting of the second currency into the relevant sub-accounts at step 110. In particular, the step 112 includes sub-step 112a of debiting, by the account management module, the requested amount of the first currency (as requested at step 106, e.g. USD 10) from a sub-account for the first currency that is affiliated with the first entity. The step 112 further includes sub-step 112b of crediting, by the account management module, the debited amount of the first currency (i.e. debited at sub-step 112a, e.g. USD 10) into a sub-account for the first currency that is affiliated with the second entity. In other words, the requested amount of USD 10 is debited from the first entity's account and this debited amount of USD 10 is credited to the second entity's account, as per his request. In summary, in exchange for the requested USD 10 by the second entity, the first entity receives the equivalent amount of EUR 9.

Steps 102, 104, 106, 108, 110 and 112 may not necessarily be performed sequentially—e.g. step 112 can be performed before 110, or steps 110 and 112 can be performed in parallel.

In an implementation, an automatic top-up function may be provided. Users may choose to activate an automatic reload mechanism which converts a stored “home” currency to a “foreign” currency if the “foreign” currency falls below a set threshold. In the following description of the automatic top-up function, the first currency is the “home” currency while the “foreign” currency is the second currency. Further, the first entity is the user that intends to activate the automatic reload mechanism. It will be appreciated that the second entity can also choose to activate the automatic reload mechanism.

The first step involves retrieving, by the account management module, a threshold amount of the second currency to be maintained in the sub-account for the second currency that is affiliated with the first entity. The second step involves determining, by the account management module, an available amount of the second currency in the sub-account for the second currency that is affiliated with the first entity. In this context, the “available amount of the second currency” refers to the amount of “foreign” currency funds currently available in the user's account. The third step involves comparing, by the account management module, the available amount and the threshold amount of the second currency.

If the available amount is less than the threshold amount of the second currency (i.e. the “foreign” currency has fallen below the set threshold), the following three steps (fourth to sixth step) are performed to convert the “home” currency to the “foreign” currency in order to top-up the “foreign” currency to a level above the user-defined threshold amount. The fourth step involves determining, by the transaction management module, a shortfall amount of the second currency that corresponds to a difference between the available amount and the threshold amount of the second currency. The fifth step involves determining, by the transaction management module, an equivalent shortfall amount of the first currency that is equivalent to the shortfall amount of the second currency converted based on the broadcasted currency exchange rate. The sixth step involves debiting, by the account management module, the determined equivalent shortfall amount of the first currency from the sub-account for the first currency that is affiliated with the first entity, and crediting, by the account management module, the shortfall amount of the second currency into the sub-account for the second currency that is affiliated with the first entity. In this manner, the “foreign” currency amount is reloaded to an amount equal to the user-defined threshold amount.

In a typical currency exchange market, there are many entities, each wishing to transact in different currency pairs. For example, one entity may want to obtain US Dollars in exchange for Euros, while another entity may want to obtain US Dollars in exchange for Japanese Yen. In an implementation, a preliminary check or search may be performed to match a first entity that wishes to obtain a first currency in exchange for a second currency with a second entity that wishes to obtain same the second currency in exchange for the same first currency. That is, entities that wish to transact in the same currency pair (e.g. USD-EUR) are matched.

Accordingly, the aforementioned preliminary check or search may involve the following steps: (i) receiving, at the transaction management module, an indication from the first entity of the second currency in exchange for the first currency; and (ii) receiving, at the transaction management module, an indication from the second entity of the first currency in exchange for the second currency. If the second currency (e.g. EUR) in exchange for the first currency (e.g. USD) (i.e. the indication from the first entity), corresponds to the first currency (e.g. USD) in exchange for the second currency (e.g. EUR) (i.e. the indication from the second entity), there is a match. If there is a match, the currency exchange rate between the first currency and the second currency may be broadcasted (refer to step 104). In this manner, entities are only informed of currency exchange rates that they are interested in and a match has been made.

There may be occasions where an entity wishes to obtain a first currency in exchange for a second currency, but he/she may have insufficient funds of the second currency to make the exchange. Continuing from the above example where the broadcasted currency exchange rate between US Dollars (USD) and Euros (EUR) is USD 1 to EUR 0.90, assume that the entity wishes to obtain USD 100 (the first currency) in exchange for EUR 90 (the second currency). A preliminary check can be performed to confirm that the entity has at least EUR 90 to make the exchange.

Accordingly, in response to receiving the request from the second entity for the requested amount of the first currency in exchange for the second currency at the broadcasted currency exchange rate (refer to step 106), the following two steps may be performed: (A) determining, by the account management module, an available amount of the second currency (e.g. EUR) in the sub-account for the second currency that is affiliated with the second entity; (B) comparing, by the account management module, the determined available amount (at step (A) above) and the determined equivalent amount of the second currency (at step 108 above). If the determined available amount is more than the determined equivalent amount of the second currency (i.e. the user has sufficient funds to make the exchange), the subsequent steps of method 100 (e.g. steps 110 and 112) can be performed. In particular, step 110a of debiting, by the account management module, the determined equivalent amount of the second currency from the sub-account for the second currency that is affiliated with the second entity can be performed.

On the other hand, if the determined available amount is less than the determined equivalent amount of the second currency (i.e. the user has insufficient funds to make the exchange), the method 100 may be terminated and the currency exchange does not occur. Alternatively, the currency exchange may be limited to the determined available amount of the second currency only.

In the above description of method 100, it is assumed that the first entity and second entity are different or separate entities. However, it is possible that there may be only a single entity involved in the method for currency exchange. For example, a user has a multi-currency account that has multiple sub-accounts for each of the different currencies. The user is able to obtain more of a particular currency in exchange for another currency by transferring funds from one sub-account to another sub-account. For example, the user has just visited a foreign country and is about to return to his home country and has some excess foreign currency. Instead of changing the excess foreign currency to his home currency at a currency exchange counter/bureau de change kiosk, the user can deposit the excess foreign currency into his multi-currency account and, at his convenience, exchange the excess foreign currency to his home currency.

Consequently, there is provided a method for currency exchange for a single entity, according to another embodiment. The method includes a first step of providing, by an account management module, an account (i.e. a multi-currency account) for the entity, the account comprising a plurality of sub-accounts for a different currency. The second step involves broadcasting a currency exchange rate between a first currency and a second currency. In this context, broadcasting may refer to informing the single entity, by any suitable means, the currency exchange rate between a first currency and a second currency. For example, the currency exchange rate may be sent to a user output module that is part of a mobile electronic device (e.g. smart phone) belonging to the user. The user output module may be a display screen with associated processor(s) and microcontroller(s) capable of displaying the currency exchange rate.

The third step involves receiving, at a transaction management module in communication with the account management module, a request for a requested amount of the first currency in exchange for a second currency at the broadcasted currency exchange rate. The fourth step involves determining, by the transaction management module, an equivalent amount of the second currency that is equivalent to the requested amount of the first currency converted based on the broadcasted currency exchange rate. The fifth step involves debiting, by the account management module, the determined equivalent amount of the second currency from a sub-account for the second currency, and crediting, by the account management module, the requested amount of the first currency into a sub-account for the first currency.

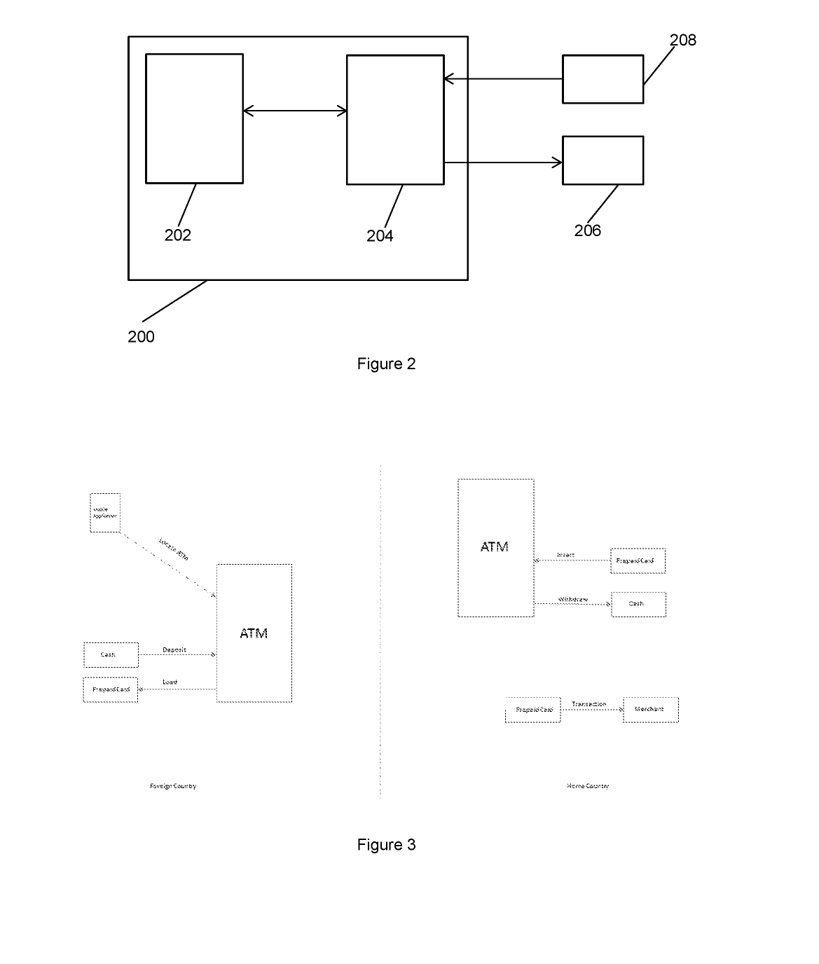

FIG. 2 is a schematic of a system 200 for currency exchange between a first entity and a second entity, according to an example embodiment. The system is suitable for performing one or more steps of the method 100 that is described above. The system 200 includes an account management module 202 and a transaction management module 204 in communication with the account management module 202.

The transaction management module 204 is configured to broadcast a currency exchange rate between a first currency and a second currency. For example, the transaction management module 204 is configured to transmit the currency exchange rate between the first currency and the second currency to a user output module 206 that is in communication with the transaction management module 204. The user output module 206 is not part of the system 200 but may be part of a mobile electronic device (e.g. smart phone) belonging to the first and/or second entity. The user output module may be a display screen with associated processor(s) and microcontroller(s) capable of displaying the currency exchange rate.

The transaction management module 204 is also configured to receive a request from the second entity for a requested amount of the first currency in exchange for the second currency at the broadcasted currency exchange rate; and determine an equivalent amount of the second currency that is equivalent to the requested amount of the first currency converted based on the broadcasted currency exchange rate.

The transaction management module 204 may be further configured to receive an offered currency exchange rate between the first currency and the second currency from a user input module 208 of the first entity, wherein the broadcasted currency exchange rate is based on the offered currency exchange rate. The user input module 208 is in communication with the transaction management module 204 and is not part of the system 200 but may be part of a mobile electronic device (e.g. smart phone) belonging to the first and/or second entity. Alternatively or additionally, the transaction management module 204 may be further configured to receive a pre-determined currency exchange rate between the first currency and the second currency, wherein the broadcasted currency exchange rate is based on the pre-determined currency exchange rate.

The account management module 202 is configured to provide an account each for the first and second entities. Each account includes a sub-account for the first currency and a sub-account for the second currency. The account management module 202 is also configured to debit the determined equivalent amount of the second currency from a sub-account for the second currency that is affiliated with the second entity, and credit the debited amount of the second currency into a sub-account for the second currency that is affiliated with the first entity.

The account management module 202 is further configured to debit the requested amount of the first currency from a sub-account for the first currency that is affiliated with the first entity, and credit the debited amount of the first currency into a sub-account for the first currency that is affiliated with the second entity.

In order to implement the automatic top-up function described above in relation to method 100, the account management module 202 may be further configured to: (i) retrieve a threshold amount of the second currency to be maintained in the sub-account for the second currency that is affiliated with the first entity; (ii) determine an available amount of the second currency in the sub-account for the second currency that is affiliated with the first entity; and (iii) compare the available amount and the threshold amount of the second currency. The transaction management module 204 may be further configured to: (i) determine a shortfall amount of the second currency corresponding to a difference between the available amount and the threshold amount of the second currency; and (ii) determine an equivalent shortfall amount of the first currency that is equivalent to the shortfall amount of the second currency converted based on the broadcasted currency exchange rate.

If the available amount is less than the threshold amount of the second currency as determined by the account management module 202, the account management module 202 is further configured to debit the determined equivalent shortfall amount of the first currency from the sub-account for the first currency that is affiliated with the first entity, and credit the shortfall amount of the second currency into the sub-account for the second currency that is affiliated with the first entity.

In order to implement the preliminary check/search to match a first entity that wishes to obtain a first currency in exchange for a second currency with a second entity that wishes to obtain the second currency in exchange for the first currency described above in relation to method 100, the transaction management module 204 may be further configured to: receive an indication from the first entity of the second currency in exchange for the first currency; and receive an indication from the second entity of the first currency in exchange for the second currency. If the second currency in exchange for the first currency corresponds to the first currency in exchange for the second currency, there is a “match” and the transaction management module 204 broadcasts the currency exchange rate between the first currency and the second currency.

If the transaction management module 204 receives the request from the second entity for the requested amount of the first currency in exchange for the second currency at the broadcasted currency exchange rate, the account management module 202 may be further configured to check if the second entity has sufficient funds of the second currency to make the exchange. In particular, the account management module 202 may be further configured to determine an available amount of the second currency in the sub-account for the second currency that is affiliated with the second entity; compare the determined available amount and the determined equivalent amount of the second currency; and, on a condition that the determined available amount is more than the determined equivalent amount of the second currency, debit the determined equivalent amount of the second currency from the sub-account for the second currency that is affiliated with the second entity.

A method for currency exchange for a single entity was described above. Accordingly, there is provided a system that is suitable for performing one or more steps of the method for currency exchange for a single entity. The system includes an account management module and a transaction management module in communication with the account management module. The transaction management module and account management module may be functionally similar to the transaction management module 204 and the account management module 202. The transaction management module is configured to: broadcast a currency exchange rate between a first currency and a second currency; receive a request for a requested amount of the first currency in exchange for a second currency at the broadcasted currency exchange rate; and determine an equivalent amount of the second currency that is equivalent to the requested amount of the first currency converted based on the broadcasted currency exchange rate. The account management module is configured to: provide an account for the entity, the account comprising a sub-account for the first currency and a sub-account for the second currency; and debit the determined equivalent amount of the second currency from the sub-account for the second currency, and credit the requested amount of the first currency into the sub-account for the first currency.

Embodiments described above seek to give foreign currencies a “second life”, allowing them to be stored on a multi-currency prepaid card and/or be exchanged to another currency either through a mobile baking account or ATM cash withdrawal at the traveller's next travel destination. Accordingly, all ATM cash withdrawals are now local cash withdrawals.

The following three example scenarios illustrate how the above-described method(s) and/or system(s) for currency exchange may be utilized. Travellers (leisure and business travellers) are issued a multi-currency prepaid card and a traveller's mobile banking account. The prepaid card allows travellers to deposit their remaining foreign currencies at ATMs while the mobile banking account allows them to track their finances on the go.

The first scenario is mainly directed to the method(s) and system(s) for currency exchange for a single entity. With reference to FIG. 3, in this first scenario, the single entity, Jane, is coming back home to Singapore after her holiday in Japan. Jane has some Japanese Yen remaining and uses a mobile application installed on her mobile electronic device to locate the nearest automated teller machines (ATMs) from her location. Typically, there is an ATM at the airport to facilitate cash deposits before one flies out of the country. She arrives at an ATM in Japan and deposits the remaining Japanese Yen into her multi-currency prepaid account using her multi-currency prepaid card. The remaining Japanese Yen is stored and can be withdrawn the next time she travels to Japan. She can also choose to withdraw the loaded Japanese Yen in Singapore Dollars when she is back in Singapore at a local Singapore ATM. This is based on the assumption that both the foreign and local ATMs allow access to the multi-currency prepaid account.

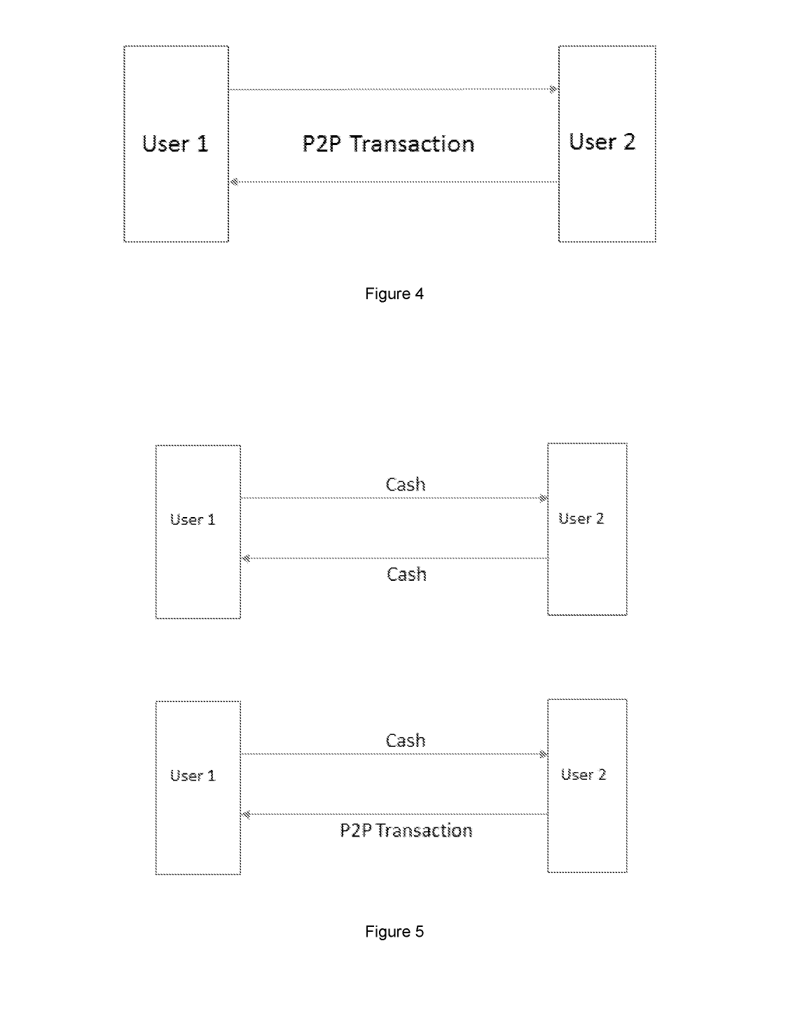

The second and third scenarios are mainly directed to the method(s) and system(s) for currency exchange between multiple entities. With reference to FIG. 4, in the second scenario, there are two entities, User 1 and User 2 (i.e. a first entity and a second entity). User 1, Mike, is a frequent business traveller. He typically travels around Asia. However, this time round he needs to go to the United States. Mike has several foreign currencies (e.g. Japanese Yen, Korean Won, Chinese Yuan Renminbi) stored in his multi-currency account. As most of his expenses are going to be charged on his corporate card, Mike understands that he only needs to carry a small amount of US Dollars. Unfortunately, currency exchange counters prefer not to conduct such low value transactions. Mike can log on to his mobile banking account to change all his remaining foreign currencies into US Dollars. Mike has two options. One, to make a peer-to-peer (P2P) transaction with a friend/friends who currently has US Dollars loaded into their account. They have an option to either transact using an exchange rate determined mutually between the parties involved or the current market exchange rate. Two, convert all/some of his loaded foreign currencies into US Dollars in an open market with a market determined exchange rate. A mobile application installed on Mike's mobile electronic device can show him the amount of US Dollars he can withdraw from a local ATM when he arrives in the United States.

With reference to FIG. 5, in the third scenario, there are two entities, User 1 and User 2 (i.e. a first entity and a second entity). User 1, Mary, is in a rush and unable to deposit her remaining cash at an overseas ATM before flying back home (unlike Jane in the first scenario). Mary logs on to her mobile banking account. Using a mobile application installed on her mobile electronic device, she makes a post on her social network platforms e.g. Facebook, Twitter, etc. that she has some Japanese Yen and would like to exchange them for another currency. Through her post, friends within her social network are able to make an offer. Depending on the currency offered, there is a recommend market exchange rate. Once the “seller” accepts the offer quoted by the “buyer”, both parties can set a time to meet up and deal. User 1 and User 2 can both meet in person and exchange cash, or User 1 can provide cash while User 2 can load User 1's prepaid multi-currency card via a P2P transaction or any other medium over an electronic financial transaction network.

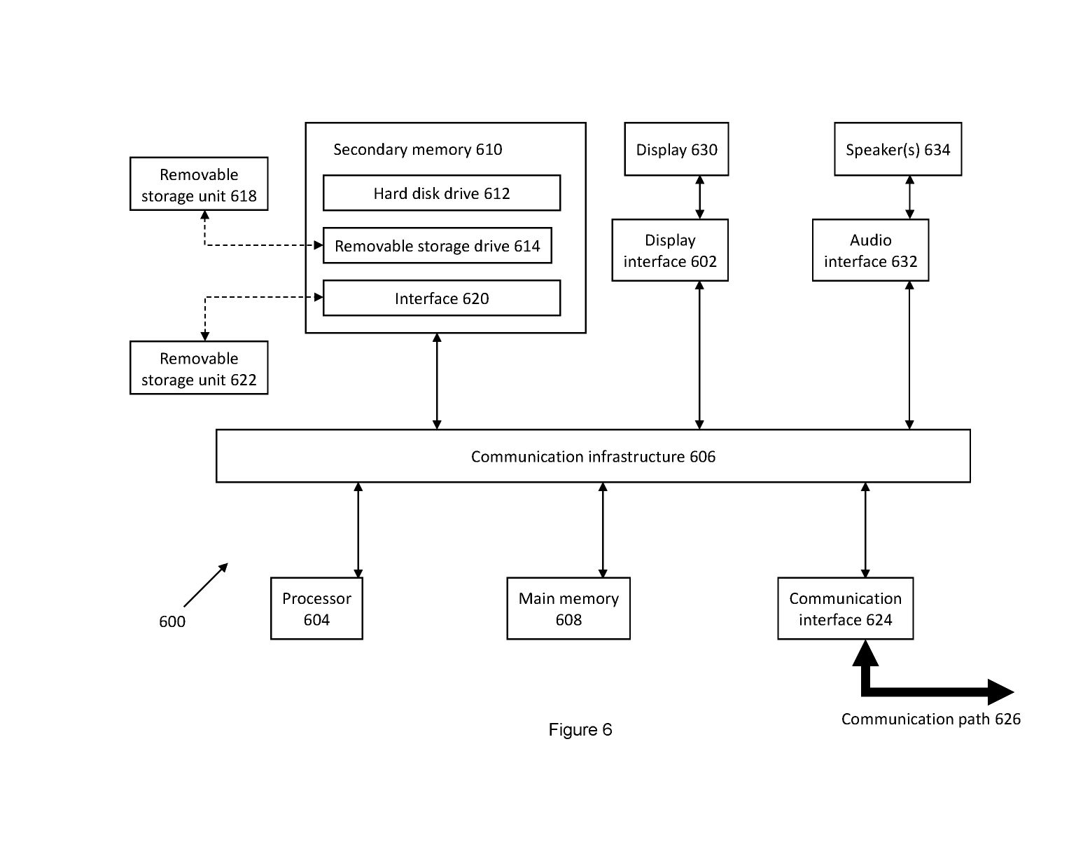

FIG. 6 shows a schematic diagram of a computer device/system 600 suitable for use in executing one or more steps of the above-described methods for currency exchange. One or more such computing devices 600 may be used to execute the above-described methods for currency exchange. In addition, one or more components of the computer system 600 may be used to realize the system 200 for currency exchange, the account management module 202 and/or the transaction management module 204. The following description of the computing device 600 is provided by way of example only and is not intended to be limiting.

As shown in FIG. 6, the example computing device 600 includes a processor 604 for executing software routines. Although a single processor is shown for the sake of clarity, the computing device 600 may also include a multi-processor system. The processor 604 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 610. The secondary memory 610 may include, for example, a hard disk drive 612 and/or a removable storage drive 614, which may include a magnetic tape drive, an optical disk drive, or the like. The removable storage drive 614 reads from and/or writes to a removable storage unit 618 in a well-known manner. The removable storage unit 618 may include a magnetic tape, optical disk, or the like, which is read by and written to by removable storage drive 614. As will be appreciated by persons skilled in the relevant art(s), the removable storage unit 618 includes a computer readable storage medium having stored therein computer executable program code instructions and/or data.

In an alternative implementation, the secondary memory 610 may additionally or alternatively include other similar means for allowing computer programs or other instructions to be loaded into the computing device 600. Such means can include, for example, a removable storage unit 622 and an interface 620. Examples of a removable storage unit 622 and interface 620 include a program cartridge and cartridge interface (such as that found in video game console devices), a removable memory chip (such as an EPROM or PROM) and associated socket, and other removable storage units 622 and interfaces 620 which allow software and data to be transferred from the removable storage unit 622 to the computer system 600.

The computing device 600 also includes at least one communication interface 624. The communication interface 624 allows software and data to be transferred between computing device 600 and external devices via a communication path 626. In various embodiments of the inventions, the communication interface 624 permits data to be transferred between the computing device 600 and a data communication network, such as a public data or private data communication network. The communication interface 624 may be used to exchange data between different computing devices 600 which such computing devices 600 form part an interconnected computer network. Examples of a communication interface 624 can include a modem, a network interface (such as an Ethernet card), a communication port, an antenna with associated circuitry and the like. The communication interface 624 may be wired or may be wireless. Software and data transferred via the communication interface 624 are in the form of signals which can be electronic, electromagnetic, optical or other signals capable of being received by communication interface 624. These signals are provided to the communication interface via the communication path 626.

As shown in FIG. 6, the computing device 600 further includes a display interface 602 which performs operations for rendering images to an associated display 630 and an audio interface 632 for performing operations for playing audio content via associated speaker(s) 634.

As used herein, the term “computer program product” may refer, in part, to removable storage unit 618, removable storage unit 622, a hard disk installed in hard disk drive 612, or a carrier wave carrying software over communication path 626 (wireless link or cable) to communication interface 624. Computer readable storage media refers to any non-transitory tangible storage medium that provides recorded instructions and/or data to the computing device 600 for execution and/or processing. Examples of such storage media include floppy disks, magnetic tape, CD-ROM, DVD, Blu-Ray™ Disc, a hard disk drive, a ROM or integrated circuit, USB memory, a magneto-optical disk, or a computer readable card such as a PCMCIA card and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 610. Computer programs can also be received via the communication interface 624. Such computer programs, when executed, enable the computing device 600 to perform one or more features of embodiments discussed herein. In various embodiments, the computer programs, when executed, enable the processor 604 to perform features of the above-described embodiments. Accordingly, such computer programs represent controllers of the computer system 600.

Software may be stored in a computer program product and loaded into the computing device 600 using the removable storage drive 614, the hard disk drive 612, or the interface 620. Alternatively, the computer program product may be downloaded to the computer system 600 over the communications path 626. The software, when executed by the processor 604, causes the computing device 600 to perform functions of embodiments described herein.

It is to be understood that the embodiment of FIG. 6 is presented merely by way of example. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for currency exchange between a first entity and a second entity, comprising:
providing, by an account management module, an account each for the first and second entities, each account comprising a plurality of sub-accounts for a different currency;
broadcasting a currency exchange rate between a first currency and a second currency;
receiving, at a transaction management module in communication with the account management module, a request from the second entity for a requested amount of the first currency in exchange for the second currency at the broadcasted currency exchange rate;
determining, by the transaction management module, an equivalent amount of the second currency that is equivalent to the requested amount of the first currency converted based on the broadcasted currency exchange rate;
debiting, by the account management module, the determined equivalent amount of the second currency from a sub-account for the second currency that is affiliated with the second entity, and crediting, by the account management module, the debited amount of the second currency into a sub-account for the second currency that is affiliated with the first entity; and
debiting, by the account management module, the requested amount of the first currency from a sub-account for the first currency that is affiliated with the first entity, and crediting, by the account management module, the debited amount of the first currency into a sub-account for the first currency that is affiliated with the second entity.

2. The method as claimed in claim 1, further comprising:
receiving, at the transaction management module, an offered currency exchange rate between the first currency and the second currency, wherein the broadcasted currency exchange rate is based on the offered currency exchange rate.

3. The method as claimed in claim 2, further comprising:
transmitting the offered currency exchange rate from a user input module of the first entity to the transaction management module.

4. The method as claimed in claim 1, further comprising:
receiving, at the transaction management module, a pre-determined currency exchange rate between the first currency and the second currency, wherein the broadcasted currency exchange rate is based on the pre-determined currency exchange rate.

5. The method as claimed in claim 1, further comprising:
retrieving, by the account management module, a threshold amount of the second currency to be maintained in the sub-account for the second currency that is affiliated with the first entity;
determining, by the account management module, an available amount of the second currency in the sub-account for the second currency that is affiliated with the first entity;
comparing, by the account management module, the available amount and the threshold amount of the second currency; and on a condition that the available amount is less than the threshold amount of the second currency,
determining, by the transaction management module, a shortfall amount of the second currency corresponding to a difference between the available amount and the threshold amount of the second currency;
determining, by the transaction management module, an equivalent shortfall amount of the first currency that is equivalent to the shortfall amount of the second currency converted based on the broadcasted currency exchange rate;
debiting, by the account management module, the determined equivalent shortfall amount of the first currency from the sub-account for the first currency that is affiliated with the first entity, and crediting, by the account management module, the shortfall amount of the second currency into the sub-account for the second currency that is affiliated with the first entity.

6. The method as claimed in claim 1, further comprising:
receiving, at the transaction management module, an indication from the first entity of the second currency in exchange for the first currency; and
receiving, at the transaction management module, an indication from the second entity of the first currency in exchange for the second currency,
wherein the step of broadcasting the currency exchange rate between the first currency and the second currency is performed on a condition that the second currency in exchange for the first currency corresponds to the first currency in exchange for the second currency.

7. The method as claimed in claim 1, wherein in response to receiving the request from the second entity for the requested amount of the first currency in exchange for the second currency at the broadcasted currency exchange rate, the method further comprises:
determining, by the account management module, an available amount of the second currency in the sub-account for the second currency that is affiliated with the second entity;
comparing, by the account management module, the determined available amount and the determined equivalent amount of the second currency; and on a condition that the determined available amount is more than the determined equivalent amount of the second currency,
debiting, by the account management module, the determined equivalent amount of the second currency from the sub-account for the second currency that is affiliated with the second entity.

8. The method as claimed in claim 1, wherein the step of broadcasting the currency exchange rate between the first currency and the second currency comprises:
transmitting the currency exchange rate between the first currency and the second currency from the transaction management module to a user output module of the first entity and/or second entity.

9. A method for currency exchange for an entity, comprising:
providing, by an account management module, an account for the entity, the account comprising a plurality of sub-accounts for a different currency;
broadcasting a currency exchange rate between a first currency and a second currency;
receiving, at a transaction management module in communication with the account management module, a request for a requested amount of the first currency in exchange for a second currency at the broadcasted currency exchange rate;
determining, by the transaction management module, an equivalent amount of the second currency that is equivalent to the requested amount of the first currency converted based on the broadcasted currency exchange rate; and
debiting, by the account management module, the determined equivalent amount of the second currency from a sub-account for the second currency, and crediting, by the account management module, the requested amount of the first currency into a sub-account for the first currency.

10. A system for currency exchange between a first entity and a second entity, comprising: an account management module; and
a transaction management module in communication with the account management module,
wherein the transaction management module is configured to:
broadcast a currency exchange rate between a first currency and a second currency;
receive a request from the second entity for a requested amount of the first currency in exchange for the second currency at the broadcasted currency exchange rate; and
determine an equivalent amount of the second currency that is equivalent to the requested amount of the first currency converted based on the broadcasted currency exchange rate,
and wherein the account management module is configured to:
provide an account each for the first and second entities, each account comprising a sub-account for the first currency and a sub-account for the second currency;
debit the determined equivalent amount of the second currency from a sub-account for the second currency that is affiliated with the second entity, and credit the debited amount of the second currency into a sub-account for the second currency that is affiliated with the first entity; and
debit the requested amount of the first currency from a sub-account for the first currency that is affiliated with the first entity, and credit the debited amount of the first currency into a sub-account for the first currency that is affiliated with the second entity.

11. The system as claimed in claim 10, wherein the transaction management module is further configured to receive an offered currency exchange rate between the first currency and the second currency from a user input module of the first entity, wherein the broadcasted currency exchange rate is based on the offered currency exchange rate.

12. The system as claimed in claim 10, wherein the transaction management module is further configured to receive a pre-determined currency exchange rate between the first currency and the second currency, wherein the broadcasted currency exchange rate is based on the pre-determined currency exchange rate.

13. The system as claimed in claim 10, wherein the account management module is further configured to:
retrieve a threshold amount of the second currency to be maintained in the sub-account for the second currency that is affiliated with the first entity;
determine an available amount of the second currency in the sub-account for the second currency that is affiliated with the first entity; and
compare the available amount and the threshold amount of the second currency; wherein the transaction management module is further configured to:
determine a shortfall amount of the second currency corresponding to a difference between the available amount and the threshold amount of the second currency; and
determine an equivalent shortfall amount of the first currency that is equivalent to the shortfall amount of the second currency converted based on the broadcasted currency exchange rate, on a condition that the available amount is less than the threshold amount of the second currency as determined by the account management module,
and wherein the account management module is further configured to:
debit the determined equivalent shortfall amount of the first currency from the sub-account for the first currency that is affiliated with the first entity, and credit the shortfall amount of the second currency into the sub-account for the second currency that is affiliated with the first entity.

14. The system as claimed in claim 10, wherein the transaction management module is further configured to:
receive an indication from the first entity of the second currency in exchange for the first currency;
receive an indication from the second entity of the first currency in exchange for the second currency; and
broadcast the currency exchange rate between the first currency and the second currency on a condition that the second currency in exchange for the first currency corresponds to the first currency in exchange for the second currency.

15. The system as claimed in claim 10, wherein in response to the transaction management module receiving the request from the second entity for the requested amount of the first currency in exchange for the second currency at the broadcasted currency exchange rate, the account management module is further configured to:
determine an available amount of the second currency in the sub-account for the second currency that is affiliated with the second entity;
compare the determined available amount and the determined equivalent amount of the second currency; and on a condition that the determined available amount is more than the determined equivalent amount of the second currency,
debit the determined equivalent amount of the second currency from the sub-account for the second currency that is affiliated with the second entity.

16. The system as claimed in claim 10, wherein the transaction management module is further configured to transmit the currency exchange rate between the first currency and the second currency to a user output module that is in communication with the transaction management module.

17. A system for currency exchange for an entity, comprising:
an account management module; and
a transaction management module in communication with the account management module,
wherein the transaction management module is configured to:
broadcast a currency exchange rate between a first currency and a second currency;
receive a request for a requested amount of the first currency in exchange for a second currency at the broadcasted currency exchange rate;
determine an equivalent amount of the second currency that is equivalent to the requested amount of the first currency converted based on the broadcasted currency exchange rate;
and wherein the account management module is configured to:
provide an account for the entity, the account comprising a sub-account for the first currency and a sub-account for the second currency; and
debit the determined equivalent amount of the second currency from the sub-account for the second currency, and credit the requested amount of the first currency into the sub-account for the first currency.
